(19) United States
(12) Patent Application Publication
(10) Pub. No.: US 2011/0257877 A1
(43) Pub. Date: Oct. 20, 2011

(54) GUIDANCE SYSTEM AND METHOD FOR TAKING PUBLIC TRANSPORTATION

(75) Inventors: HUNG-HUAN LIU, CHUNG LI (TW); KAI-CHIH CHAN, CHUNG LI (TW); YU-JEN CHANG, CHUNG LI (TW); YUNG-JU CHEN, CHUNG LI (TW); WEI-HSUN CHEN, CHUNG LI (TW); YAO-JEN CHANG, CHUNG LI (TW)

(73) Assignee: CHUNG YUAN CHRISTIAN UNIVERSITY, CHUNG LI (TW)

(21) Appl. No.: 12/947,176

(22) Filed: Nov. 16, 2010

(30) Foreign Application Priority Data
Apr. 20, 2010 (TW) 099112262

(51) Int. Cl. G01C 21/00

(52) U.S. Cl. 701/201

(57) ABSTRACT

The present invention provides a guidance system and a guidance method for taking public transportation, which comprise a mobile device having a mobile positioning unit and a mobile interface unit. After the mobile interface unit receives destination information, the mobile positioning unit produces text guidance information according to location information and the destination information. The mobile interface unit displays the text guidance information for guiding people the way to the platform of the public transportation and helping people to confirm the public transportation to take.

### FIELD OF THE INVENTION

The present invention relates generally to a guidance system and method, and particularly to a guidance system and a guidance method for taking public transportation.

### BACKGROUND OF THE INVENTION

In order to save the traffic time for entering urban areas as well as reducing unnecessary ways, mass transit systems are commonly built in or between towns. A general mass transit system, such as a rapid-transit system, buses, trains, or high-speed rails, sets different numbers of stops depending on areas and urban planning. The distribution of the stops is broad. For example, trains or mass rapid transit systems generally have various lines. Although modern mass transit systems provide the distribution of traffic routes around the stops for people to enter or exit the stops via multiple entrances or exits, the general guidance is passive and limited in the station areas. The exact locations of destinations are not informed concretely. Besides, while inquiring, it is necessary to search and compare on a large map, and therefore the method is not ideal. Furthermore, the guidance of how to take the mass transit systems if a person wishes to get to a destination is not provided effectively.

Many guidance devices are developed for solving the problems described above. Current guidance devices guide based on the global positioning system (GPS). They use a positioning module to real-timely provide the current location of a user. By means of the positioning module, the current location of the user can be monitored. For example, according to the Taiwan patent application number 94210668 entitled “Personal mobile guidance device”, the guidance information for movers taking public transportation is provided. However, during operational process, the type of public transportation has to be selected first, which is very inconvenient for people just arriving an unfamiliar place. Thereby, the Taiwan patent number 1292819, named “Guidance device and method for using public transportation”, is developed for solving the problem. The guidance device has database for storing the data of public transportation; real-timely extracts the current location of a user using a positioning module; and monitors the routes of the user. When the user moves to a transit node or a preparation node on the guidance itinerary, a reminder message is provided for instructing the user to getting on or off the vehicle.

However, the prior arts described above are guidance devices based on GPS, which positions according to satellite signals. When the public transportation is underground, passing through tunnels, or other reasons, the satellite signals are sheltered, making the guidance devices lose the satellite signals. If the guidance devices lose the satellite signals, the guidance devices will re-find the satellite signals and reconfirm the itinerary. For people in public transportation, they tend to miss the original destination stops during the process of the guidance devices re-finding the satellite signals and reconfirming the itinerary. For people unfamiliar with the public transportation, they don't realize that they have missed the original destination until they ask the station personnel or the service personnel in the vehicle. Then they have to enquire for remedial measures. The process of enquiry and confirmation costs substantial time, resulting in much inconvenience for the people taking the public transportation.

In addition, current guidance devices cannot return their locations to the corresponding servers for inquiry. If the user of the guidance device has an accident, there will be no responses to the accident immediately. Moreover, even though the guidance devices are popular in the present day, some people still cannot understand information in maps and will get lost. That is to say, some people cannot reach their destinations by using the guidance devices but the traffic lights, gas stations, or convenience stores. These people generally need to judge according to their experiences or ask other people. Other people may possibly indicate the wrong way because they are not clear about the geographical locations of the lost people.

Accordingly, the present invention provides a guidance system and a guidance method for taking public transportation, which can provide better guidance efficiency and thus solving the problem of missing the planned stop for people. In addition, the present invention can also return the location information timely for confirming the itinerary.

### SUMMARY

An objective of the present invention is to provide a guidance system and a guidance method for taking public transportation, which use a mobile device for guiding people to the destinations by taking public transportation.

Another objective of the present invention is to provide a guidance system and a guidance method for taking public transportation, which use access points to locate the mobile device and thus avoiding missing destination stop while the mobile device losing the satellite signals.

Still another objective of the present invention is to provide a guidance system and a guidance method for taking public transportation, which use a central control device to record the location information of the mobile device and the destination information for providing location information of the mobile device.

The present invention provide a guidance system and a guidance method for taking public transportation, which comprises a mobile device having a mobile interface unit, a mobile positioning unit, and a positioning information unit. The mobile interface unit stores the positioning information of a plurality of access points. Because the positioning information corresponds to the locations of the plurality of access points, the mobile positioning unit can position the mobile device according to the positioning information and produce location information. In addition, after the mobile interface unit receives destination information, the mobile positioning unit produces text guidance information according to the location information and the destination information. The mobile interface unit displays the lines of the public transportation to be taken according to the text guidance information for the people to confirm if the public transportation taken is wrong and if the direction is false. Besides, the present invention further comprises a central control device, a database, and a managerial terminal device. The database stores map information corresponding to the public transportation. The central control device receives the location information and the destination information, and reads the map information according to the destination information and the location information and records to the database. The central control device also stores the text guidance information to the database. The managerial terminal device manages the central control device and the database.

### BRIEF DESCRIPTION OF THE DRAWINGS

FIG. 1 shows a block diagram according to an embodiment of the present invention;

FIG. 2A shows a schematic diagram of connecting to an access point according to an embodiment of the present invention;

FIG. 2B shows a schematic diagram of connecting to an access point according to another embodiment of the present invention;

FIG. 3 shows a flowchart according to an embodiment of the present invention;

FIG. 4 shows a flowchart according to another embodiment of the present invention;

FIG. 5A shows a flowchart according to another embodiment of the present invention; and

FIG. 5B shows a schematic diagram of taking public transportation according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

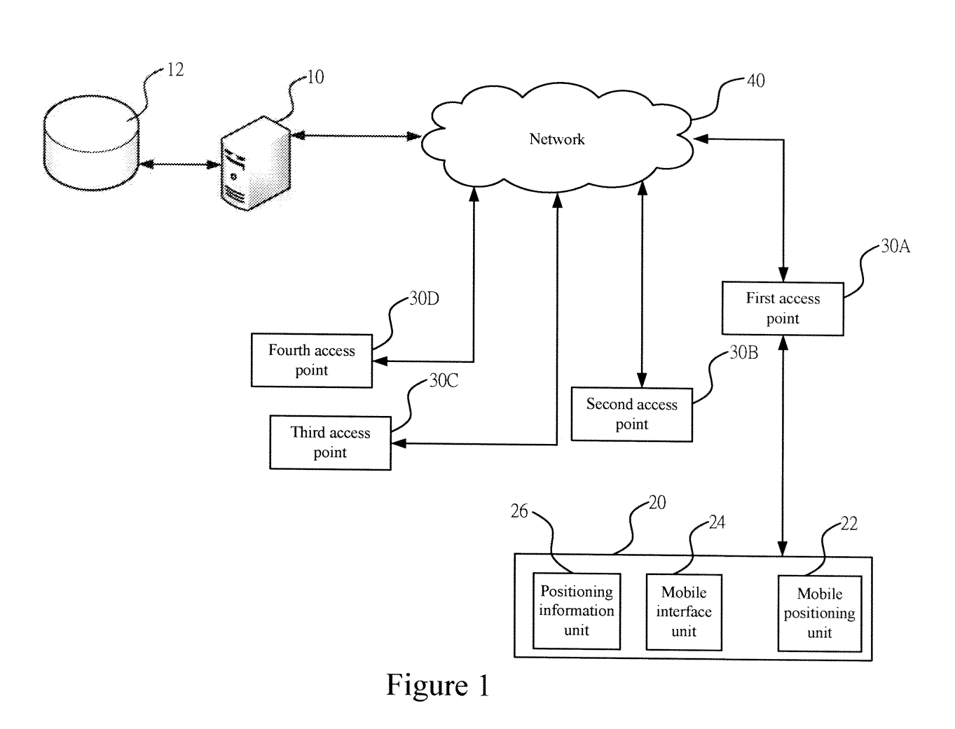

FIG. 1 shows a block diagram according to an embodiment of the present invention. As shown in the figure, the present invention is a guidance system applied to taking public transportation. The system according to the present invention comprises a central control device 10 and a mobile device 20. The mobile device 20 is connected to the central control device 10, and includes a mobile positioning unit 22, a mobile interface unit 24, and a positioning information unit 26. Besides, the central control device 10 further connects to a database 12. The mobile device 20 according to the present invention connects to a network 40 via one of a plurality of access points 30A, 30B, 30C, 30D, and then to the central control device 10. The case of connecting the mobile device 20 to the first access point 30A is used as an example. However, the present invention is not limited to the case. The mobile device 10 according to the present invention can connect to the network 40 via other methods, such as 3.5G mobile networking. The positioning information unit 26 according to the present invention stores the positioning information of the plurality of access points 30A, 30B, 30C, 30D as well as the MAC addresses and addresses of plurality of access points 30. The mobile device 20 connects to the network 40 via one of the access points 30A, 30B, 30C, 30D. The mobile positioning unit 24 performs positioning according to the address information of the connected access point 30 and gives the geographical location of the mobile device 20 and location information. In addition, the positioning information of the plurality of access points 30A, 30B, 30C, 30D can be further stored in the database 12. Thereby, the positioning information unit 26 can download the positioning information of the plurality of access points 30A, 30B, 30C, 30D stored in the database 12. After a user inputs destination information to the mobile interface unit 24, the mobile positioning unit 22 calculates according to the location information and the destination information, gives the itineraries of the user, and selects the itinerary most suitable for the user to take the public transportation. The mobile positioning unit 22 then produces text guidance information and transmits it to the mobile interface unit 24, which displays where to take the public transportation, which stop to get off, and which way to go after getting off according to the text guidance information. Namely, the text guidance information provides how and where to take the public transportation. According to the present embodiment, the rapid-transit system is used as an example of the public transportation. However, the present invention is not limited to the example.

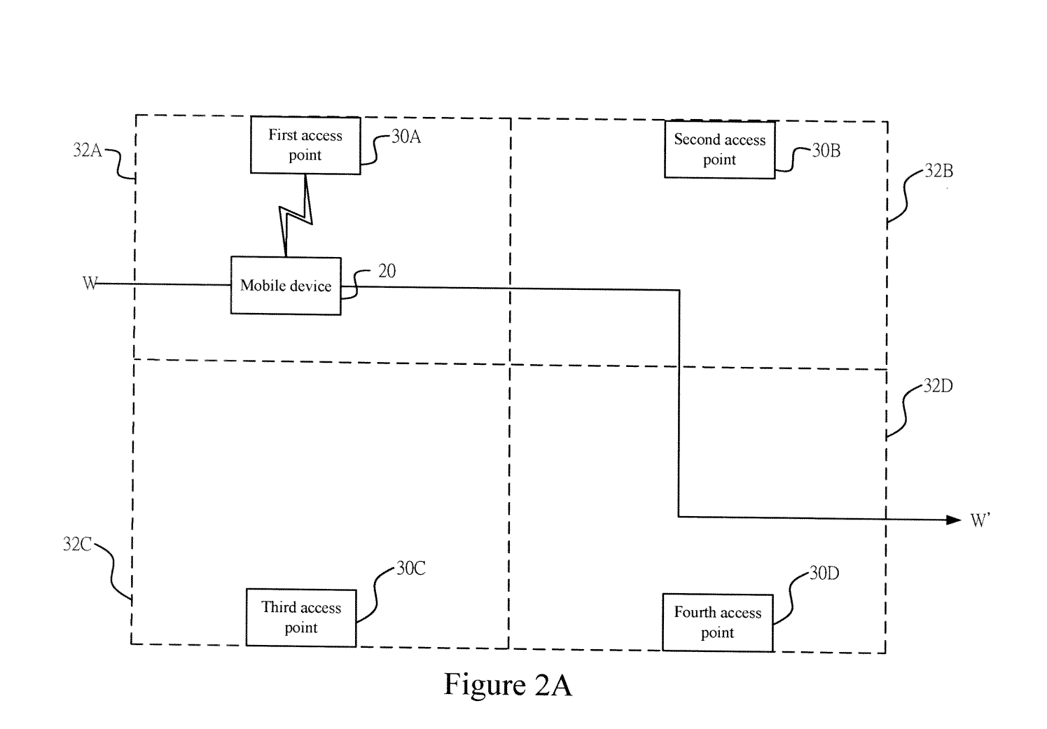

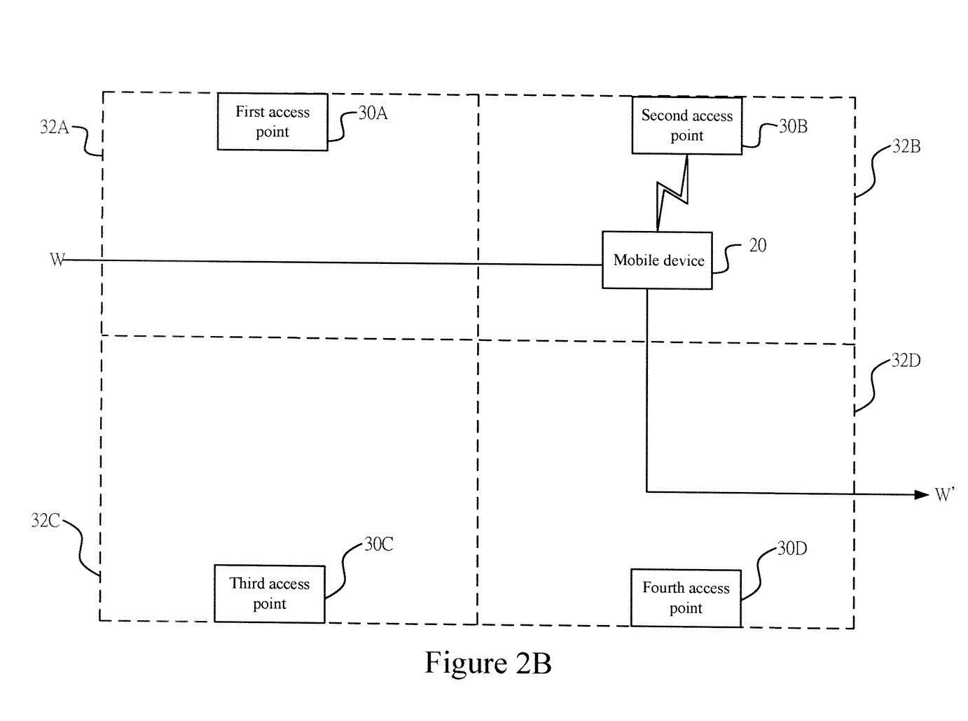

As shown in FIG. 2A and FIG. 2B, the plurality of access points 30A, 30B, 30C, 30D are disposed in the blocks 32 of a map. The effective range of signals for each of the access points 30A, 30B, 30C, 30D is the corresponding size of the blocks 32A, 32B, 32C, 32D. Each access point has address information. According to the present embodiment, the address information of the plurality of access points 30A, 30B, 30C, 30D is their MAC addresses, respectively. Thereby, according to the present invention, when the mobile device 20 detects one of the access points 30A, 30B, 30C, 30D, the mobile positioning unit 22 performs positioning according the MAC address of the access point detected by the mobile device 20 and gives the corresponding geographical location, and hence locating the block of the access point detected by the mobile device 20. For example, the first access point 30A corresponds to the first block 32A; the second access point 30B corresponds to the first block 32B; the third access point 30C corresponds to the first block 32C; the fourth access point 30D corresponds to the first block 32D. When the mobile device 20 detects the first access point 30A, the mobile positioning unit 22 locates the mobile device 20 to the first block 32A.

Besides, the mobile positioning unit 22 according to the present invention can further know the location of the mobile device 20 according to the positioning message provided by the GPS and further positions the user's mobile device 20, and hence providing the route plan after the public transportation, for example, the direction after exiting the station. Thereby, if the satellite signals are lost, the mobile positioning unit 22 still can perform positioning. The text guidance information prevents misunderstanding of iconic labels. The text guidance information also changes according to the change of the location information. Accordingly, the user of the mobile device 20 can receive the correct instructions. Moreover, because the address information of the access points 30 is fixed, the network addresses of the plurality of access points 30 can be stored beforehand in the positioning information unit 26. The mobile positioning unit 22 according to the present invention can have the starting point set by the user before starting off. The location information is input to the mobile interface unit 24, and hence the mobile positioning unit 22 can use the location information to calculate and give the text guidance information.

Refer again to FIG. 2A and FIG. 2B. According to the present embodiment, four blocks 32A, 32B, 32C, 32D are used as examples. The route WW′ is the path of the user of the mobile device 20 passing through the blocks 32A, 32B, 32C, 32D according to the text guidance information displayed by the mobile interface unit 24. As shown in FIG. 21 when the mobile device 20 is in the first block 32A, the mobile device 20 can detect the first access point 30A, and thereby the mobile positioning unit 22 gives the location information, which is in the first block 32A, of the mobile device 20 according to the address information, such as MAC address, of the first access point 30A. On the other hand, as shown in FIG. 2B, when the mobile device 20 is in the second block 32B, the mobile device 20 can detect the second access point 30B, and thereby the mobile positioning unit 22 gives the location information, which is in the second block 32B, of the mobile device 20 according to the address information, such as MAC address, of the second access point 30B. Accordingly, the mobile positioning unit 22 can perform positioning according to the address information of the access point 30 and give the location information.

Referring back to FIG. 1, the database 12 stores map information corresponding to the public transportation. After the mobile interface unit 24 encrypts and transmits the location information and the destination information of the user to the central control device 10, the central control device 10 reads the map information from the database 12 according to the location information and the destination information, and records the location and destination of the user of the mobile device 20 to the map information. The central control device 10 can provide the user status recorded in the database 12 via a management interface. Thereby, the user's family or friends can connect to the central control device 10. After identity authentication and data decryption, the location information and the destination information of the user of the mobile device 20 are given. For example, the central control device 10 provides a webpage link showing the map information stored in the database 12.

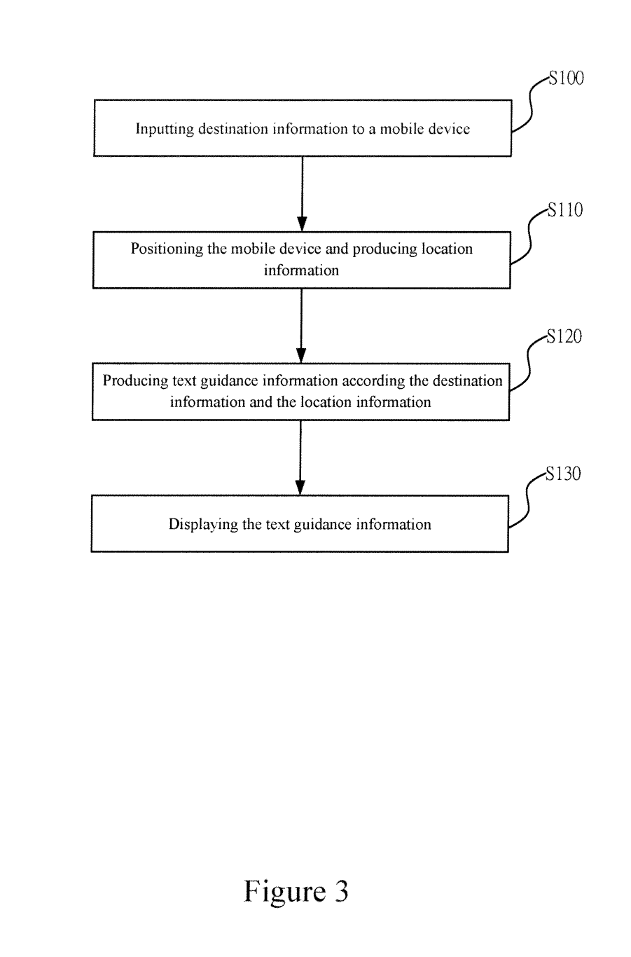

FIG. 3 shows a flowchart according to an embodiment of the present invention. As shown in the figure, the guidance method for taking public transportation comprises steps of:
Step S100: Inputting destination information to a mobile device;
Step S110: Positioning the mobile device and producing location information;
Step S120: Producing text guidance information according the destination information and the location information; and
Step S130: Displaying the text guidance information.

In the step S100, the user inputs the planned destination to the mobile device 20, namely, the mobile interface unit 24. In the step S110, the mobile positioning unit 22 of the mobile device 20 performs positioning according to the corresponding positioning information of the plurality of access points. The positioning information includes address information and the corresponding geographical locations of the plurality of access points. Besides, the mobile positioning unit 22 according to the present embodiment can further perform positioning and produce the location information according to positioning information provided by a GPS. In the step S120, the mobile positioning unit 22 produces the text guidance information according to the location information and the destination information. In the step S130, the mobile interface unit 24 of the mobile device 20 displays the text guidance information for instructing the user of the mobile device 20 to take the public transportation according to the text information shown on the mobile interface unit 24. That is, the text guidance information includes the lines of the public transportation to be taken.

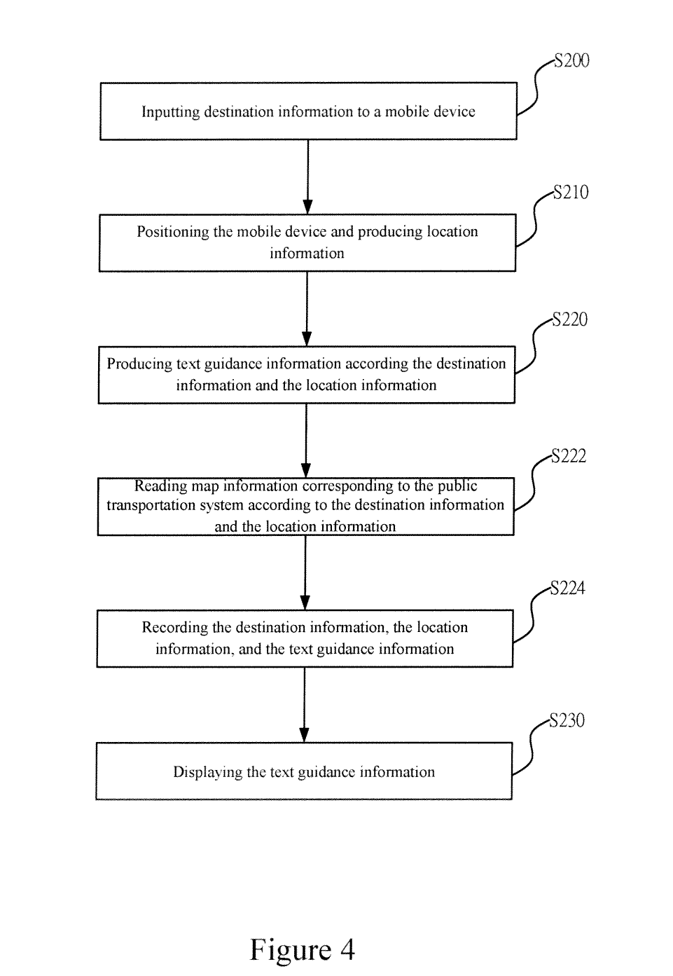

FIG. 4 shows a flowchart according to another embodiment of the present invention. As shown in the figure, the guidance method for taking public transportation comprises steps of:
Step S200: Inputting destination information to a mobile device;
Step S210: Positioning the mobile device and producing location information;
Step S220: Producing text guidance information according the destination information and the location information;
Step S222: Reading map information corresponding to the public transportation system according to the destination information and the location information;
Step S224: Recording the destination information, the location information, and the text guidance information; and
Step S230: Displaying the text guidance information.

The difference between the present embodiment and the previous one is that after the step of producing text guidance information, the present embodiment further comprises the steps S222 and S224. In the step 220, the mobile interface unit 24 further transmits the destination information and the location information of the user to a central control device 10. In the step S222, the central control device 10 reads the map information corresponding to the destination information and the location information. In the step S224, the central control device 10 records the destination information and the location information of the user to the map information and stores them to the database 12. Thereby, people can inquire the map information stored in the database 12 through the network. In other words, the user, his friends, or his family can inquire the location of the user of the mobile device 20 via the network. Alternatively, the rescuers can know the location of the user immediately by inquiring the database 12 once the user of the mobile device 20 happens to have some accidents.

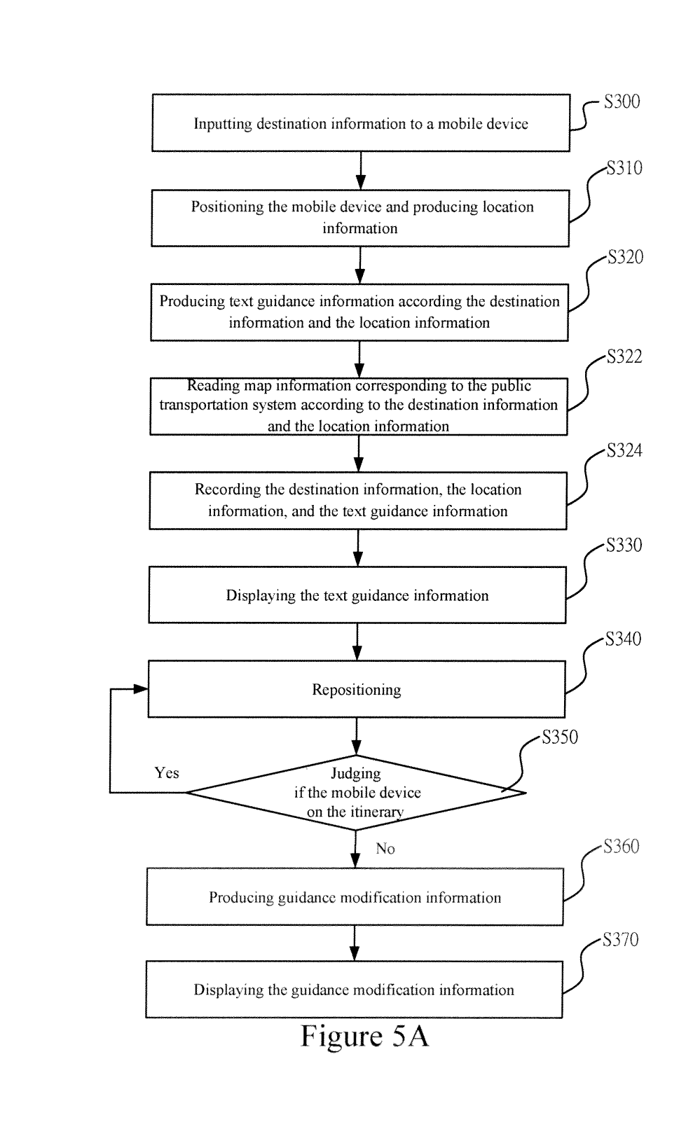

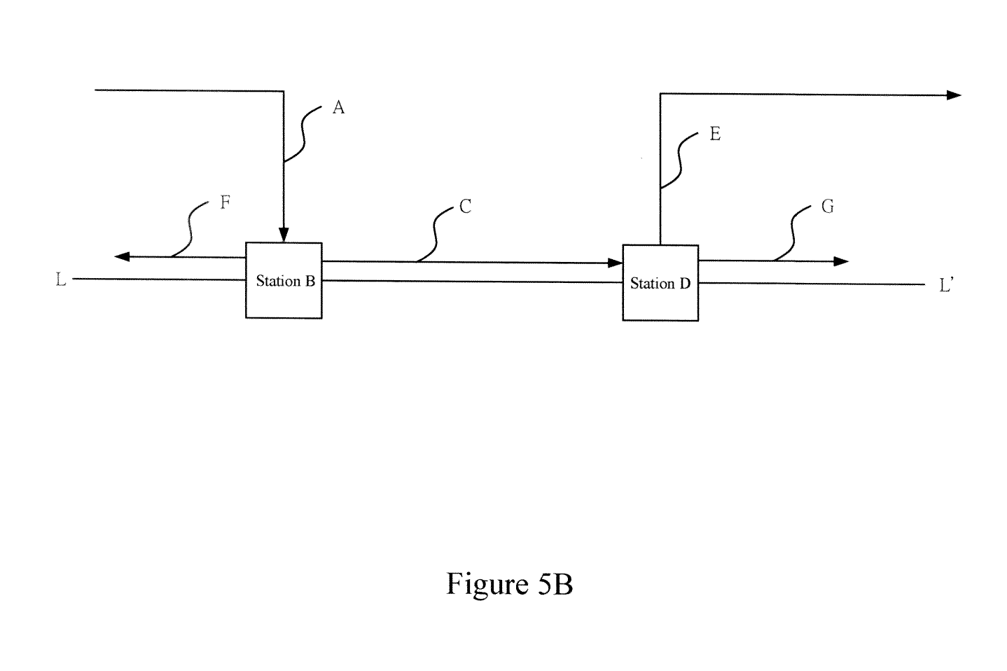

FIG. 5 shows a flowchart according to another embodiment of the present invention. As shown in the figure, the guidance method for taking public transportation comprises steps of:
Step S300: Inputting destination information to a mobile device;
Step S310: Positioning the mobile device and producing location information;
Step S320: Producing text guidance information according the destination information and the location information;
Step S322: Reading map information corresponding to the public transportation system according to the destination information and the location information;
Step S324: Recording the destination information, the location information, and the text guidance information;
Step S330: Displaying the text guidance information;
Step S340: Repositioning;
Step S350: Judging if the mobile device on the itinerary;
Step S260: Producing guidance modification information; and
Step S370: Displaying the guidance modification information.

The difference between the present embodiment and the previous one is that the present embodiment further comprises the steps S340, S350, S360, and S370. In the step S340, the mobile positioning unit 22 repositions the mobile device 20, such as positioning according to the GPS or to the access point, and produces the location information of the mobile device 20. In the step S350, the mobile positioning unit 22 judges if the location information on the itinerary. If yes, then the step S360 is executed; if not, then the step S340 is executed. In the step S360, the mobile positioning unit 22 produces a modified itinerary and guidance modification information. Namely, the guidance for the user of the mobile device 20 will be modified. Thereby, when the direction is wrong or when he misses the stop, he still can reach the destination. For example, if the user misses the stop while taking the train, the mobile interface unit 24 will display “After reaching the first platform of the next stop, go to the second platform of the inverse direction to take the train in reverse direction”. Thereby, the user can be guided to return to the planned destination stop.

As shown in FIG. 5B, taking the rapid transit for example, the route LL′ is the course of the public transportation (the rapid transit). The user of the mobile device 20 goes to the platform B (such as a rapid-transit station) following a first route A. Then he takes the public transportation to go through a second route C and reach the platform D. Next, he walks out of the platform D following the third route E. If the user of the mobile device 20 takes the wrong direction at the platform B, namely, he takes the inverse direction of the second route C, such as the fourth route F, and does not reach the station C, the mobile device 20 will send a warning message, such as rings, vibrations, or warning text, to the user. Meanwhile, the mobile device 20 will report the error message back to the central control device 10 via the wireless network connected by the access point or cellular network. Then, the central control device 10 will send a message to the user himself, the user's friends, or the user's relatives for informing false taking of public transportation. Besides, the mobile positioning unit 22 will produce the corresponding modified itinerary and the guidance modification information according to the current location information. The mobile interface unit 24 displays the guidance modification information according to the modified itinerary produced in the step S360. Then the user of the mobile device 20 can reach the platform D according to the guidance modification information displayed on the mobile interface unit 24. In addition, if the direction of the user of the mobile device 20 is correct and he fails to exit the station from the platform D, he may go exceeding the platform D, such as the fifth route G. Then the mobile device 20 will sends a warning message to the user as well. And the mobile interface unit 24 will also display the guidance modification information according to the modified itinerary produced in the step S360. Thereby the user of the mobile device 20 can reach the platform D according to the guidance modification information displayed on the mobile interface unit 24.

To sum up, the present invention provides a guidance system and a guidance method for taking public transportation. The location information is acquired by the mobile positioning unit of the mobile device according to the positioning information of the access point of the wireless network. The mobile interface unit is used for receiving the destination information of the user. The mobile positioning unit produces the text guidance information according to the location information and the destination information. The mobile interface unit displays according to the text guidance information and guides the user of the mobile device the way to take the public transportation and the route of the user. In addition, the user of the mobile device or his friends or relatives can inquire the location of the user by the network.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A guidance method for taking public transportation, comprising steps of:
inputting destination information to a mobile device;
positioning said mobile device and producing location information;
producing text guidance information according said destination information and said location information; and
displaying said text guidance information, said text guidance information providing the method and place for taking said public transportation.

2. The guidance method for taking public transportation of claim 1, wherein said step of producing said text guidance information according said destination information and said location information further comprises steps of:
reading map information corresponding to said public transportation according to said destination information and said location information; and
recording said destination information, said location information, and said text guidance information to said map information.

3. The guidance method for taking public transportation of claim 1, wherein said mobile device in said step of positioning said mobile device and producing said location information positions according to positioning information provided by a global positioning system or according to corresponding positioning information of a plurality of access points for producing said location information.

4. The guidance method for taking public transportation of claim 3, wherein said positioning information includes address information of said plurality of access points and a plurality of geographical locations corresponding to said address information.

5. The guidance method for taking public transportation of claim 1, and further comprising steps of:
repositioning and producing said location information; and
judging if said location information not on the itinerary, producing guidance modification information, and displaying said guidance modification information.

6. A guidance system for taking public transportation, comprising:
a mobile interface unit, disposed in a mobile device, and receiving destination information; and
a mobile positioning unit, disposed in said mobile device, positioning said mobile device, producing location information, producing text guidance information according to said location information and said destination information, said mobile interface unit receiving and displaying said text guidance information, and said text guidance information providing the method and place for taking said pubic transportation.

7. The guidance system for taking public transportation of claim 6, and further comprising:
a central control device, receiving said location information, said destination information, and said text guidance information; and
a database, storing map information corresponding to said public transportation, said central control device reading said map information according to said destination information and said location information, and said central control device recording said destination information, said location information and said text guidance information to said map information.

8. The guidance system for taking public transportation of claim 6, wherein said mobile positioning unit further positions said mobile device according to positioning information provided by a global positioning system or according to corresponding positioning information of a plurality of access points for producing said location information.

9. The guidance system for taking public transportation of claim 8, wherein said positioning information includes address information of said plurality of access points and a plurality of geographical locations corresponding to said address information.

10. The guidance system for taking public transportation of claim 6, wherein once said mobile positioning unit judges that said location information exceeds the itinerary, said mobile positioning unit further produces guidance modification information, and said mobile interface unit receives and displays said guidance modification information.
